(19) United States
(12) Patent Application Publication
(10) Pub. No.: US 2006/0245071 A1
(43) Pub. Date: Nov. 2, 2006

(54) Lens correction element, system and method

(75) Inventors: David M. George, Los Gatos, CA (US); William Clay Schluchter, Los Altos, CA (US); Robert Todd Belt, Mountain View, CA (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(73) Assignee: Agilent Technologies

(21) Appl. No.: 11/119,471

(22) Filed: Apr. 29, 2005

(51) Int. Cl. G02B 3/12

(52) U.S. Cl. 359/665

(57) ABSTRACT

A lens assembly is provided that has an index-of-refraction invariant structure. In one embodiment, a void between two lenses or lens elements in a lens assembly is filled with a desired gas, liquid or vacuum, the gas, liquid or vacuum having a pre-determined index of refraction. Once the void has been filled with the desired gas or liquid or been drawn down to a complete vacuum, the void is sealed by any of numerous appropriate means to render it leaktight. The lens assembly may then be tested or calibrated to ensure an appropriate level of optical performance prior to subsequent deployment under actual field conditions. Because the vacuum or filled void disposed in the lens assembly provides optical performance that is index-of-refraction invariant, the lens assembly may be employed successfully under widely varying atmospheric conditions and yet still provide the same high quality results.

### BACKGROUND

Displacement measuring interferometers (“DMIs”) are well known in the art, and have been used to measure small displacements and lengths to high levels of accuracy and resolution for several decades. Many types of DMIs include optical systems that appropriately collimate light emitted by laser sources prior to delivery to an interferometer assembly.

In one typical DMI application, an optical “telescope” or collimator assembly is disposed between the output provided by a helium-neon laser source and an interferometer assembly. Such a telescope or collimator typically includes a lens assembly for enlarging the diameter of the laser beam emitted by source. The enlarged beam reduces beam walk-off errors arising from rotational or translational movement of portions of the interferometry system.

Occasionally DMIs are employed in unusual environments, such in a vacuum, at high-altitude or in outer space. In such environments, the performance of optical assemblies such as collimators incorporated into DMIs calibrated for operation at sea-level may be affected negatively due to changes in the indices of refraction of gases positioned between lenses in such assemblies caused by elevation, altitude and/or atmospheric pressure changes. Unexpectedly large changes in atmospheric pressure in the field may also lead to poor optical performance of a lens assembly that has been calibrated under laboratory conditions.

To overcome the foregoing problems, DMI optical assemblies are often tested in a laboratory under vacuum conditions mimicking outer space conditions prior to deployment in outer space, thereby helping ensure proper performance under field conditions. Testing optical assemblies incorporated into DMIs under vacuum conditions, however, may require considerable expense and time. Moreover, unwitting failure to achieve a perfect vacuum, or other mistakes made during laboratory testing, may lead to improper operation in the field that may not be discovered until after the optical system has been deployed, when it may no longer be possible to make corrections.

Another solution to the problem posed by indices of refraction changing with altitude or environment might be to design a lens assembly that functions properly in a first medium having a first index of refraction (e.g., atmospheric pressure and temperature at sea level), and incorporate a removable lens in the assembly. When the assembly is transported or subjected to a second medium having a known second index of refraction (e.g., a vacuum) different from the first index of refraction, the removable lens is removed to compensate for the change in index of refraction. Such a solution, however, requires that the lens assembly be physically manipulated once it has been placed in the second medium, a task that may entail considerable expertise and expense, especially if the second medium happens to be the vacuum of outer space.

What is needed is an optical assembly that may be calibrated or tested under normal laboratory atmospheric pressure and temperature conditions, and that will later perform properly under high-altitude or outer space conditions. What is also needed is an optical assembly that may be calibrated or tested under outer space or high-altitude ambient conditions, and that will later perform properly under low altitude pressure conditions.

### SUMMARY OF THE INVENTION

In accordance with one aspect of the present invention, a lens assembly is provided that having an index-of-refraction invariant structure.

In accordance with another aspect of the present invention, a void disposed between two lenses or lens elements in a lens assembly is filled with a desired gas, liquid or vacuum, the gas, liquid or vacuum having a pre-determined index of refraction. Once the void has been filled with the desired gas, liquid or vacuum, the void is sealed by any of numerous appropriate means and preferably rendered leaktight. The lens assembly may then be tested or calibrated to ensure an appropriate level of optical performance prior to subsequent deployment under actual field conditions. Because the filled void disposed in the lens assembly provides optical performance that is index-of-refraction invariant, the lens assembly may be employed successfully under widely varying atmospheric conditions and yet still provide high quality results.

Methods of making and using the foregoing are also included within the scope of the present invention.

### BRIEF DESCRIPTIONS OF THE DRAWINGS

FIG. 1 shows a block diagram of a DMI system;

FIG. 2 illustrates lens assembly 20 being calibrated under laboratory conditions for fiber optic source 10;

FIG. 3 illustrates lens assembly 20 of FIG. 2 and its manner of operation once deployed in outer space or at high altitude;

FIG. 4 illustrates lens assembly 20 being calibrated under laboratory conditions with laser source 10;

FIG. 5 illustrates lens assembly 20 of FIG. 4 and its manner of operation once deployed in outer space or at high altitude;

FIG. 6 illustrates the manner of operation of lens assembly 20 in cooperation with fiber optic source 10 when void 45 contains a vacuum (light rays 135) and when void 45 contains air at seal level atmospheric pressure (light rays 145);

FIG. 7 illustrates the manner of operation of lens assembly 20 in cooperation with laser source 10 when void 45 contains a vacuum (light rays 135) and when void 45 contains air at seal level atmospheric pressure (light rays 145);

FIG. 8 illustrates one embodiment of lens assembly 20 of the present invention as a vacuum is being drawn on void 45 in preparation for testing of assembly 20;

FIG. 9 illustrates lens assembly 20 of FIG. 8 after a complete vacuum has been drawn on void 45 and source 10 has been activated to test the optical performance of lens assembly 20;

FIG. 10 illustrates lens assembly 20 of FIG. 8 with seal 125 disposed in access port 135, with void 45 retaining a complete vacuum after seal 125 has been installed;

FIG. 11 illustrates another embodiment of lens assembly 20 of the present invention as a vacuum is being drawn on vacuum chamber 175 and void 45 in preparation for testing of assembly 20;

FIG. 12 illustrates lens assembly 20 of FIG. 11 after a complete vacuum has been drawn on vacuum chamber 175 and void 45 and source 10 has been activated to test the optical performance of lens assembly 20, and

FIG. 13 illustrates lens assembly 20 of FIG. 12 with seal 125 disposed in access port 135, with void 45 retaining a complete vacuum after seal 125 has been installed and lens assembly 20 has been removed from vacuum chamber 175.

### DETAILED DESCRIPTIONS OF THE PREFERRED EMBODIMENTS

As employed in the specification, drawings and claims hereof, the term “lens assembly 10” or “lens assembly” means a lens assembly employed for beam collimation, reduction and/or enlargement in DMI, laser, optical, communications, photographic, telephony or other applications. The term is not intended to be limited to DMI applications, which are used here for descriptive and illustrative purposes only. After having read and understood the present specification, drawings and claims hereof, those skilled in the art will understand that various embodiments of the present invention may be employed in many applications beyond distance measuring interferometers.

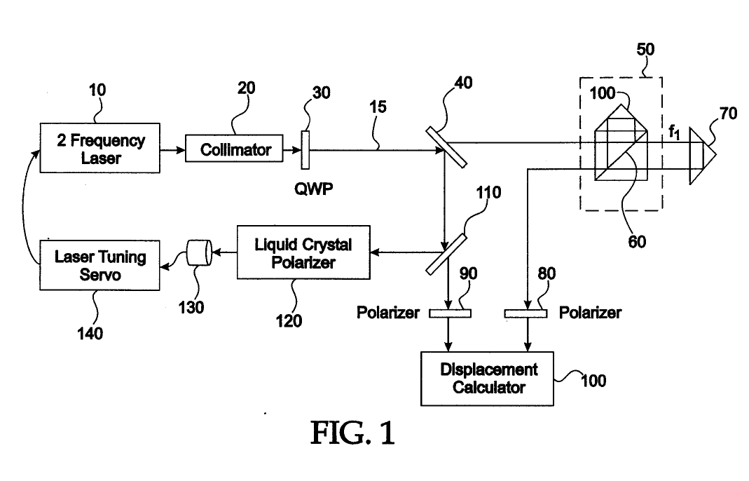

FIG. 1 shows a block diagram of a DMI system, and depicts portions of an Agilent Model Number 10705 Linear Interferometer system. Telescope or collimator 20 includes a lens assembly 20 (not shown in FIG. 1) for enlarging the diameter of the laser beam emitted by source 10 from 1 mm to 9 mm. The diameter of the laser beam emitted by source 10 is enlarged to minimize beam walk-off errors arising from undesired rotational or translational movement of portions of the system, such as movement of interferometer 50 or measurement cube corner 70.

Aspects of the DMI illustrated in FIG. 1 are disclosed in the following U.S. patents, the respective entireties of which are hereby incorporated by reference herein: U.S. Pat. No. 5,064,280 to Bockman entitled “Linear-and-angular measuring plane mirror interferometer;” U.S. Pat. No. 6,542,247 to Bockman entitled “Multi-axis interferometer with integrated optical structure and method for manufacturing rhomboid assemblies;” and U.S. Pat. No. 5,667,768 to Bockman entitled “Method and interferometric apparatus for measuring changes in displacement of an object in a rotating reference frame.”

As mentioned above, occasionally DMIs are employed in unusual environments, such as in vacuum chambers, at high-altitude on mountaintops or in high-flying aircraft, or in space loads rocketed beyond the earth's atmosphere into outer space. In such environments, the performance of optical assemblies such as telescopes incorporated into DMIs that have been calibrated for operation at sea-level may be affected negatively due to changes in the indices of refraction of the gases or liquids positioned between lenses in such assemblies as elevation or altitude changes. In another undesirable scenario, a lens assembly calibrated under laboratory or manufacturing conditions is subjected in the field to unexpectedly large changes in atmospheric pressure that also induce changes in the indices of refraction of the gases positioned between the assembly's lenses.

To overcome the foregoing problems, DMI optical assemblies may be tested in a laboratory under vacuum conditions mimicking outer space conditions prior to deployment in outer space, thereby helping ensure proper performance under field conditions. Testing optical assemblies incorporated into DMIs under vacuum conditions, however, may require considerable expense and time. Moreover, unwitting failure to achieve a perfect vacuum, or other mistakes made during laboratory testing, may lead to improper operation in the field that may not be discovered until after the optical system has been deployed, when it may no longer be possible to make corrections.

Another solution to the problem posed by indices of refraction changing with altitude or environment might be to design a lens assembly that functions properly in a first medium having a first index of refraction (e.g., atmospheric pressure and temperature at sea level), and incorporate a removable lens in the assembly. When the assembly is transported or subjected to a second medium having a known second index of refraction (e.g., a vacuum) different from the first index of refraction, the removable lens is removed to compensate for the change in index of refraction. Such a solution, however, requires that the lens assembly be physically manipulated once it has been placed in the second medium, a task that may entail considerable expertise and expense if the second medium happens to be the vacuum of outer space.

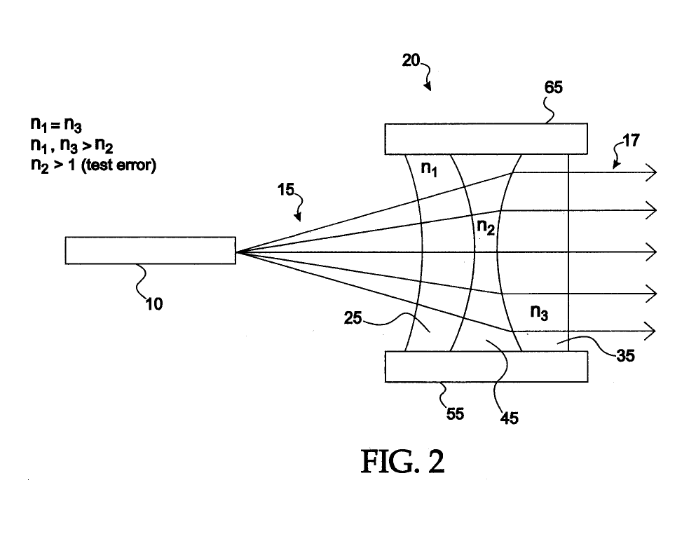

FIG. 2 illustrates lens assembly 20 being calibrated under laboratory conditions for fiber optic source 10. In practice, fiber optic source 10 may be cemented to lens assembly 20 prior to or during testing and/or calibration to ensure appropriate optical registration and alignment between source 10 and lens elements 25 and 35. Additionally, the positions of lens elements 25 and 35 may be shifted during testing or calibration to ensure proper optical registration and alignment between lens elements 25 and 35 and source 110. Frame elements 55 and 65 may comprise a plastic, an elastomeric compound, a metal, a metal alloy, aluminum, stainless steel, titanium, niobium, and platinum, or a mixture or alloy of any of the foregoing.

Unbeknownst to the operator, a perfect vacuum has not been pulled on void 45 disposed between first lens 25 and second lens 35 of lens assembly 20. The index of refraction of void 45 is therefore greater than 1 while lens assembly 20 is being calibrated. Calibration of lens assembly 20 may involve moving first lens 25 and/or second lens 35 such that light rays 17 emerging from the forward face of second lens 35 are parallel to one another. Void 45's index of refraction may be greater than 1 because of leaks between first lens 25 or second lens 35 and frame element 65 or frame element 55. Or void 45's index of refraction may be greater than 1 owing to the equipment employed to pull the vacuum being unable to do so, or improperly indicating that a perfect vacuum has been attained. Of course, many other errors in procedure or equipment to lead to the index of refraction of void 45 having value that is undesired or unanticipated.

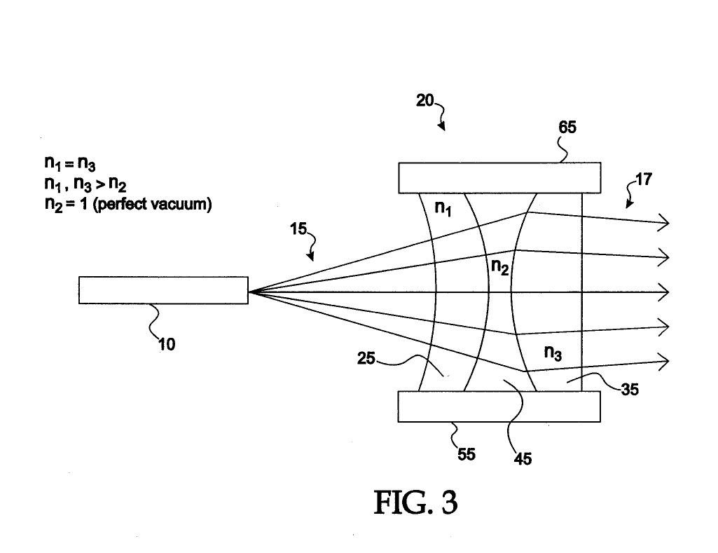

FIG. 3 illustrates lens assembly 20 of FIG. 2 and its manner of operation once it has been deployed in outer space or at high altitude. Now void 45 has an index of refraction that is equal to one (or that in any event is less than the index of refraction possessed by void 45 during calibration per FIG. 1). Light rays 17 emerging from the forward surface of lens 35 will be seen to be non-parallel to one another and to converge. Such a result would obviously be difficult, if not impossible, to cure once lens assembly 20 had been deployed into outer space.

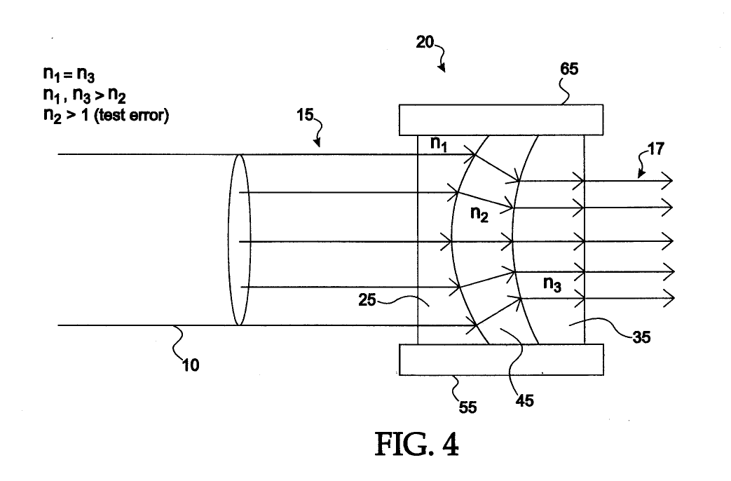

FIG. 4 illustrates lens assembly 20 being calibrated under laboratory conditions with laser source 10. As in FIG. 1, unbeknownst to the operator, a perfect vacuum has not been pulled on void 45 disposed between first lens 25 and second lens 35 of lens assembly 20. The index of refraction of void 45 is therefore greater than 1 while lens assembly 20 is being calibrated. Calibration of lens assembly 20 may involve moving first lens 25 and/or second lens 35 such that light rays 17 emerging from the forward face of second lens 35 are parallel to one another. Void 45's index of refraction may be greater than 1 because of leaks between first lens 25 or second lens 35 and frame element 65 or frame element 55. Or void 45's index of refraction may be greater than 1 owing to the equipment employed to pull the vacuum being unable to do so, or improperly indicating that a perfect vacuum has been attained. Of course, many other errors in procedure or equipment to lead to the index of refraction of void 45 having value that is undesired or unanticipated.

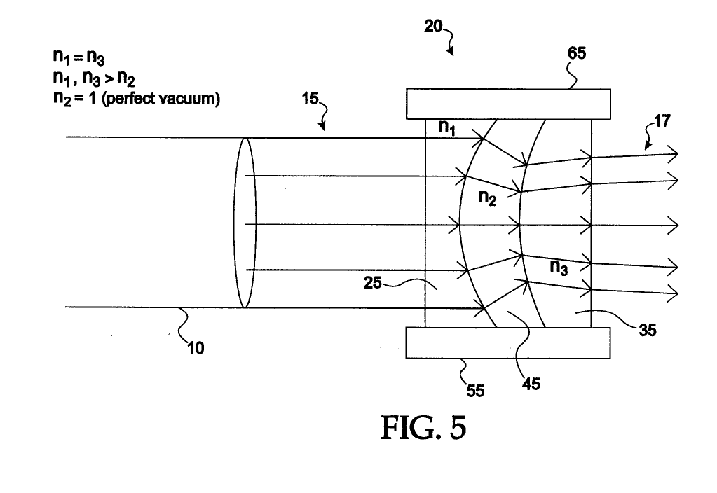

FIG. 5 illustrates lens assembly 20 of FIG. 4 and its manner of operation once it has been deployed in outer space or at high altitude. Now void 45 has an index of refraction that is equal to one (or that in any event is less than the index of refraction possessed by void 45 during calibration per FIG. 1). Light rays 17 emerging from the forward surface of lens 35 will be seen to be non-parallel to one another and to diverge. Such a result would obviously be difficult, if not impossible, to cure once lens assembly 20 had been deployed onto a mountaintop or into outer space, for example.

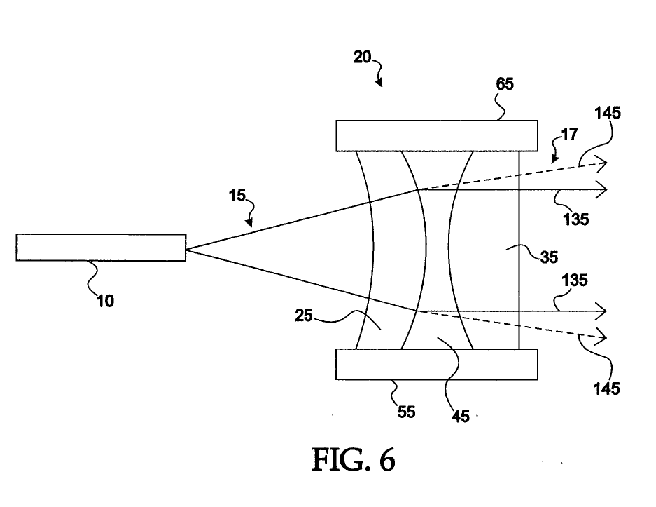

FIG. 6 illustrates the manner of operation of lens assembly 20 in cooperation with fiber optic source 10 when void 45 contains a vacuum (light rays 135), as well as when void 45 contains air at seal level atmospheric pressure (light rays 145). As will be seen, light rays 17 emerging from the forward surface of second lens 35 consist of parallel light rays 135 corresponding to void 45 having an index of refraction equaling 1 (perfect vacuum) and diverging light rays 145 corresponding to void 45 having an index of refraction being greater than 1 (e.g., seal level atmospheric pressure).

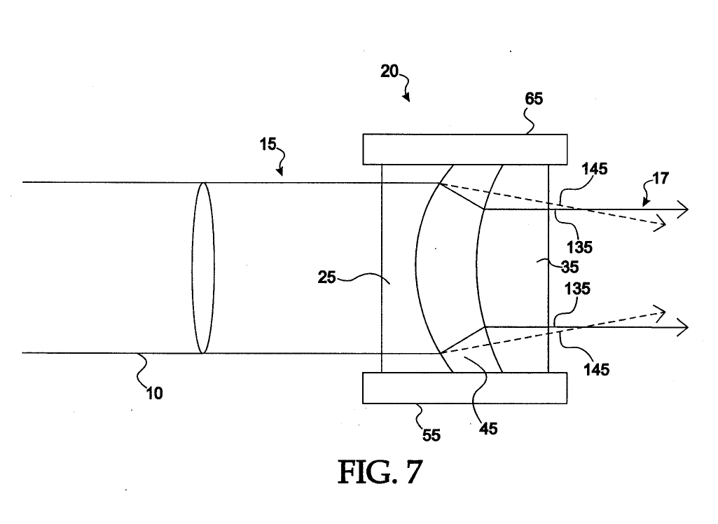

FIG. 7 illustrates the manner of operation of lens assembly 20 in cooperation with laser source 20 when void 45 contains a vacuum (light rays 135), as well as when void 45 contains air at seal level atmospheric pressure (light rays 145). As will be seen, light rays 17 emerging from the forward surface of second lens 35 consist of parallel light rays 135 corresponding to void 45 having an index of refraction equaling 1 (perfect vacuum) and converging light rays 145 corresponding to void 45 having an index of refraction being greater than 1 (e.g., seal level atmospheric pressure).

FIGS. 2 through 7 illustrate the undesired results that may obtain when a void disposed between two lenses in telescope or collimator 20 is not calibrated under appropriate conditions or has a leak path to a surrounding environment or atmosphere. What is needed is an assembly 20 that may be calibrated or tested under normal laboratory atmospheric pressure and temperature conditions, and that will later perform properly under high-altitude or outer space conditions. What is also needed is an assembly 20 that may be calibrated or tested under outer space or high-altitude ambient conditions, and that will later perform properly under low altitude temperature or pressure conditions.

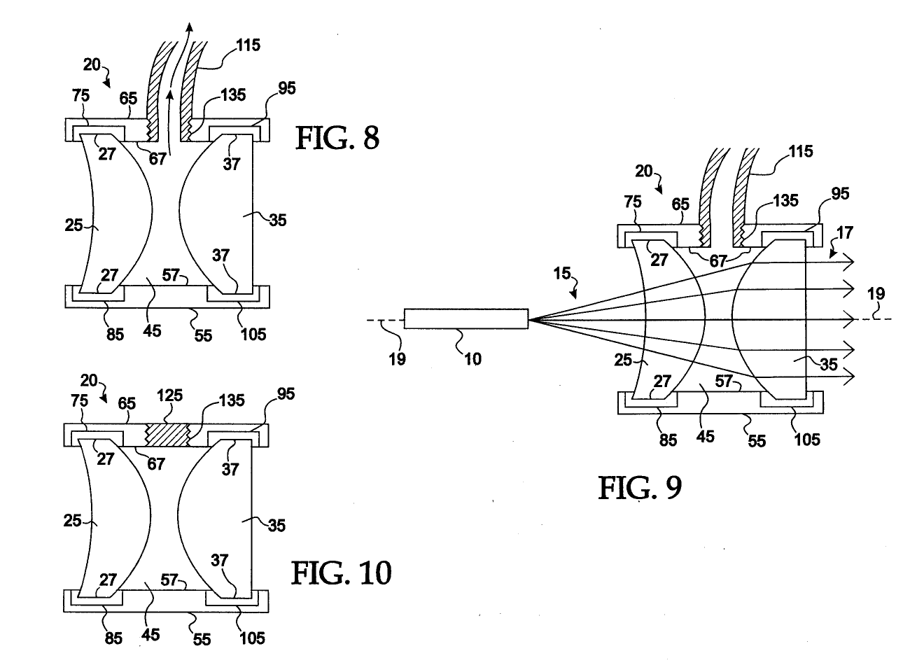

FIGS. 8 through 10 illustrate one embodiment of assembly 20 of the present invention, as well as one method of the present invention. In the embodiment of the present invention illustrated in FIGS. 8 through 10, lens assembly 20 is being prepared for subsequent deployment in space. Those skilled in the art will understand that assembly 20, and in particular void 45 and seals 75, 85, 95 and 105, could be adapted for use under other types of conditions, such as atop mountains, within the eyes of hurricanes (where atmospheric pressure is very low), in places where atmospheric pressures are expected to vary quickly in respect of time and/or substantially in respect of magnitude, and other conditions.

In FIG. 8, first lens 25 is secured to frame elements 55 and 65 by means of seals 75 and 85, and second lens 35 is secured to frame elements 55 and 65 by means of seals 95 and 105. In one embodiment of the present invention, seals 75, 85, 95 and 105 comprise an adhesive, such as an appropriately-selected industrial-grade epoxy, glue, thermo-setting glue, thermo-setting epoxy, cryano-acrylate (super-glue), or any other suitable adhesive capable of withstanding the ambient conditions to which lens assembly 20 will be exposed in such a manner that the integrity of the seal between a lens and a frame will be maintained.

In other embodiments of the present invention seals 75, 85, 95 and 105 may be compression seals comprising rubber, silicone, an elastomeric material, crush fittings comprising metal or other materials, an appropriate tape, lead, solder or brazing. Techniques employed to braze and seal feedthroughs for batteries, capacitors and/or implantable medical devices may be adapted for use in the present invention so as to secure and seal first and second lens elements 25 and 35 to frame elements 55 and 65.

In still other embodiments of the present invention seals 75, 85, 95 and 105 may be formed by frame elements 55 and 65 comprising compressible material(s) in at least those areas where first and second lenses 25 and 35 engage frame elements 55 and 65. Other types of seals capable of withstanding the ambient conditions to which lens assembly 20 will be exposed may also be employed such that the integrity of the seal(s) between a lens element and a frame may be maintained.

Continuing to refer to FIG. 8, and according to one embodiment of the device, system and method of the present invention, lens assembly 20 is prepared for testing, calibration and subsequent deployment by creating a vacuum in void 45. Atmospheric gases disposed in void 45 between first lens 25 and second lens 35 are withdrawn from void 45 by means of a suitable laboratory vacuum pump (not shown in the drawings) through void access port 135 and vacuum fittings 115 sealingly secured to void access port 135. Withdrawal of such gases from void 45 continues until such time as a complete or perfect vacuum is achieved in void 45.

As shown in FIG. 9, lens assembly 20 is next tested and/or calibrated using a suitable source such as fiber optic source 10. Light rays 17 emerging from the forward surface of second lens 35 are parallel to one another, indicating that the design parameters of lens assembly 20 have been properly executed, and that a complete vacuum has been achieved in void 45 (i.e., void 45 has an index of refraction equaling 1). Upon confirming the proper optical performance of lens assembly 20, vacuum fittings 115 are removed from void access port 135 in such a manner that the vacuum within void 45 is preserved.

As shown in FIG. 10, seal 125 is sealingly positioned in void access port 135 to render the vacuum present in void 45 permanent (or until such time as seal 125 is removed). The leaktightness of void 45 respecting external portions of lens assembly 20 may also be tested using known techniques such as helium leaktightness testing.

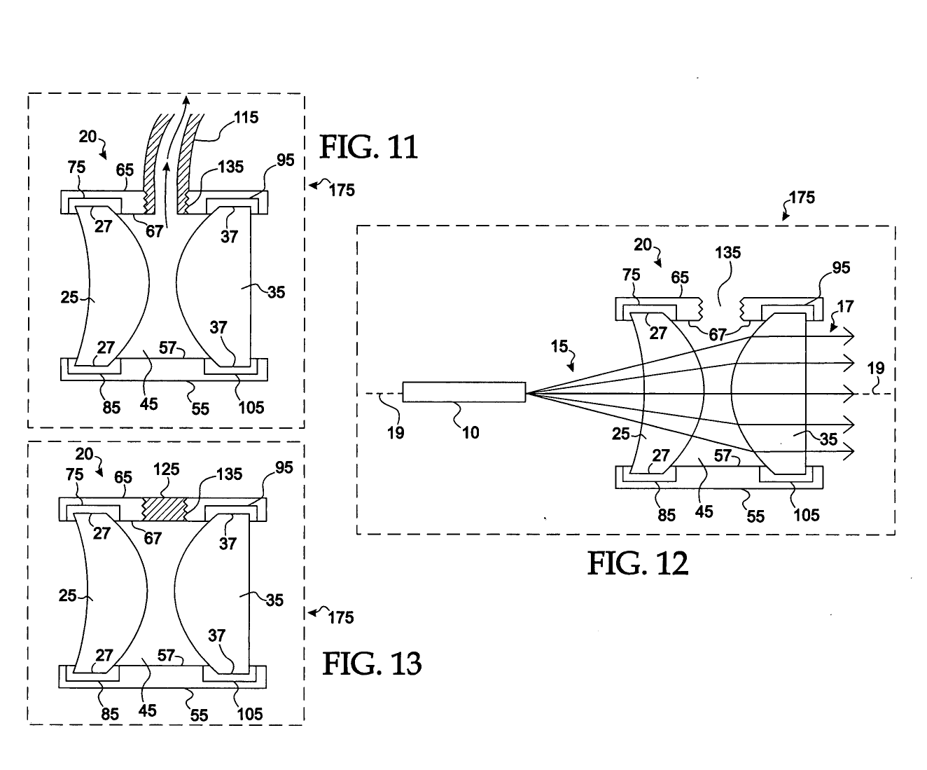

In another embodiment of the present invention, the entirety of lens assembly 20 is placed in a vacuum chamber and then subjected to a vacuum during testing and calibration. Before the vacuum is lifted and testing and/or calibration have been completed, seal 125 is sealingly fitted to void access port 45. FIG. 11 illustrates such an embodiment of the present invention, where lens assembly 20 of the present invention is disposed in vacuum chamber 175 (denoted by dashed lines) and a vacuum is drawn thereon, as well as on void 45 in preparation for testing of assembly 20. Note that void access port 135 is open.

FIG. 12 illustrates lens assembly 20 of FIG. 8 after a complete vacuum has been drawn on vacuum chamber 175 and void 45 and source 10 has been activated to test the optical performance of lens assembly 20. Provided the vacuum has been drawn completely, seal 125 may be sealingly disposed in void access port 135 before, during or after testing. Note further that the axial or other positions of lens elements 25 and 35 may be adjusted before, during or after testing and calibration to provide optimal optical performance.

FIG. 13 illustrates lens assembly 20 of FIG. 8 with seal 125 disposed in access port 135, with void 45 retaining a complete vacuum after seal 125 has been installed and lens assembly 20 has been removed from vacuum chamber 175.

The term “lens” as employed in the specification, drawings and claims hereof is interchangeable with the term “lens element.” Accordingly, and continuing to refer to FIGS. 8 through 13, optical lens assembly 20 comprises first lens element 25 and second lens element 35. Note that first lens element has first outer circumference 27, which sealingly engages seals 75 and 85, while second lens element has second outer circumference, which sealingly engages seals 95 and 105. Note that seals 75 and 85 (and/or seals 95 and 105) may comprise a single piece or mass of material that is physically continuous or contiguous, such as a compressed o-ring or a contiguous mass of adhesive.

Note that frame elements 55 and 65 may be contiguous and form a single piece or frame. Note further that frame elements 55 and 65, and outer circumferences 27 and 37, may be circular, square, rectangular or any other suitable shape. Moreover, the outer potential boundary described above and formed by inner surfaces 57 and 67 of frame elements 55 and 65 have disposed between it and void 45 intervening material such as a metal, a metal alloy, plastic, an adhesive, an elastomeric compound or a mixture of the foregoing. Additionally, frame or frame elements 55 and 65 need not be secured directly to first or second outer circumferences 27 and 37 of first and second lens elements 25 and 35 by means of adhesives, compressible or crushable seals or the like, and, for example, may instead attach to portions of the forward or rearward faces of first and second lens elements 25 and 35.

As shown in FIGS. 8 through 13, first and second lens elements 25 and 35 are spatially arranged and positioned respecting one another so as to collimate light beams 15 directed therethrough along optical axis 19 in a manner desired by a user, which in the case of FIG. 9 is output parallel light beams 17. Those skilled in the art will appreciate that beam orientations other than parallel in respect of optical axis 19 may be desired and employed in lens assembly designs of the present invention.

Continuing to refer to FIGS. 8 through 13, void 45 is disposed between first lens element 25 and second lens element 35, and in one embodiment of the present invention is further bounded by frame elements 55 and 65, frame elements 55 and 65 having inner surfaces 57 and 67, respectively. Frame elements 55 and 65 are configured to envelop at least portions of first and second outer circumferences 27 and 37. At least portions of frame inner surfaces 57 and 67 sealingly engage at least portions of seals 75, 85, 95 and 105, which in turn sealingly engage lens element outer circumferences 27 and 37. As shown in FIGS. 8 through 10, frame elements 55 and 65 may be configured such that at least portions of inner surface 57 and 67 delineating an outer diameter, boundary or periphery of void 45. Seals 75, 85, 95 and 105 operate to prevent a gas, liquid or vacuum disposed in the void from leaking therefrom. In such a manner, an index-of-refraction-invariant lens assembly 20 is provided.

Note that pressures other than a vacuum may be desired in void 45, and that gases other than air, or even appropriate liquids, may be disposed in void 45, all according to the optical or other results one might desire to obtain using a lens assembly 20 of having given design parameters.

While Schott BK-7 glass has been determined to be a particularly well-suited glass for lens assemblies of the type described herein, optically-suitable materials other than glass may be employed to construct the lens assemblies of the present invention. The present invention may be employed in single- or dual-pass interferometers, as well as in interferometers having three or more optical axes. Laser sources other than helium-neon sources may also be employed in various embodiments of the present invention. Moreover, the various structures, architectures, systems, assemblies, sub-assemblies, components and concepts disclosed herein may be employed in apparatuses and methods other than those relating to DMIs, such as in lasers, optics, communication systems, photographic devices and methods, telephony systems, and many other applications.

Accordingly, some of the claims presented herein are intended to be limited to DMI embodiments of the present invention, while other claims are not intended to be limited to the various embodiments of the present invention that are explicitly shown in the drawings or explicitly discussed in the specification hereof.

1. An optical lens assembly, comprising:
a first lens element having a first outer circumference;
a second lens element having a second outer circumference;
the first and second lens elements being spatially arranged and positioned respecting one another so as to collimate a light beam directed therethrough in a manner desired by a user;
a void disposed between the first lens element and the second lens element;
a frame, the frame having at least one inner surface and being configured to envelop the first and second outer circumferences;
at least one seal disposed between at least portions of the at least one inner surface and the first outer circumference and the second outer circumference, the at least one seal operating to prevent a gas, liquid or vacuum disposed in the void from leaking therefrom.

2. The lens assembly of claim 1, wherein the first and second lens elements are spatially arranged and positioned respecting one another so as to enlarge a diameter of the light beam incident thereon and passing therethrough.

3. The lens assembly of claim 1, wherein the first and second lens elements are spatially arranged and positioned respecting one another so as to reduce a diameter of the light beam incident thereon and passing therethrough.

4. The lens assembly of claim 1, wherein the first and second lens elements are spatially arranged and positioned respecting one another so as to focus, in a manner desired by the user, the light beam incident thereon and passing therethrough.

5. The lens assembly of claim 1, wherein at least one of the first lens element and the second lens element comprises glass.

6. The lens assembly of claim 1, wherein at least one of the first lens element and the second lens element comprises a birefringent material.

7. The lens assembly of claim 1, wherein at least one of the first lens element and the second lens element is secured and sealed to the frame by an adhesive.

8. The lens assembly of claim 1, wherein the adhesive is selected from the group consisting of epoxy, glue, thermo-setting glue, thermo-setting epoxy, and cryano-acrylate.

9. The lens assembly of claim 1, wherein at least one of the first lens element and the second lens element is secured and sealed to the frame by at least one compressible or crushable seal.

10. The lens assembly of claim 9, wherein the at least one compressible or crushable seal comprises rubber, silicone, an elastomeric material, crush fittings comprising metal or other materials, an appropriate tape, lead, solder or brazing.

11. The lens assembly of claim 1, wherein the frame comprises at least one of a plastic, an elastomeric compound, a metal, a metal alloy, aluminum, stainless steel, titanium, niobium, platinum, or a mixture or alloy of any of the foregoing.

12. The lens assembly of claim 1, wherein the lens assembly may be tested or calibrated successfully under different ambient pressures and yield the same or substantially the same optical results.

13. The lens assembly of claim 1, wherein the lens assembly is incorporated into an interferometer assembly configured to operate as a single-pass interferometer.

14. The lens assembly of claim 1, wherein the lens assembly is incorporated into an interferometer assembly configured to operate as a dual-pass interferometer.

15. The lens assembly of claim 1, wherein the lens assembly is incorporated into an interferometer assembly configured to operate as an interferometer having three or more optical axes.

16.-43. (canceled)

44. A method of making an index-of-refraction-invariant lens assembly, comprising:
providing a first lens element having a first outer circumference;
providing a second lens element having a second outer circumference;
spatially arranging and positioning the first and second lens elements respecting one another so as to collimate a light beam directed therethrough in a manner desired by a user;
disposing a void between the first lens element and the second lens element;
providing a frame, the frame having at least one inner surface and being configured to envelop the first and second outer circumferences;
providing at least one seal adapted for disposal between at least portions of the at least one inner surface and the first outer circumference and the second outer circumference, the at least one seal operating to prevent a gas, liquid or vacuum disposed in the void from leaking therefrom;
disposing the at least one seal around the first and second circumferences;
securing the frame to the first and second outer circumferences with the at least one seal being disposed therebetween, the at least one seal operating to prevent a gas, liquid or vacuum disposed in the void from leaking therefrom.

45. The method of claim 44, wherein the first and second lens elements are spatially arranged and positioned respecting one another so as to enlarge a diameter of the light beam incident thereon and passing therethrough.

46. The method of claim 44, wherein the first and second lens elements are spatially arranged and positioned respecting one another so as to focus, in a manner desired by the user, the light beam incident thereon and passing therethrough.

47. The method of claim 44, wherein at least one of the first lens element and the second lens element comprises glass.

48. The method of claim 44, wherein at least one of the first lens element and the second lens element comprises a birefringent material.

49. The method of claim 44, wherein at least one of the first lens element and the second lens element is secured and sealed to the frame by an adhesive.

50. The method of claim 49, wherein the adhesive is selected from the group consisting of epoxy, glue, thermo-setting glue, thermo-setting epoxy, and cryano-acrylate.

51. The method of claim 44, wherein at least one of the first lens element and the second lens element is secured and sealed to the frame by at least one compressible or crushable seal.

52. The method of claim 51, wherein the at least one compressible or crushable seal comprises rubber, silicone, an elastomeric material, crush fittings comprising metal or other materials, an appropriate tape, lead, solder or brazing.

53. The method of claim 44, wherein the frame comprises at least one of a plastic, an elastomeric compound, a metal, a metal alloy, aluminum, stainless steel, titanium, niobium, platinum, or a mixture or alloy of any of the foregoing.

54. The method of claim 44, wherein the lens assembly may be tested or calibrated successfully under different ambient pressures and yield the same or substantially the same optical results.
